(19) United States
(12) Patent Application Publication
(10) Pub. No.: US 2022/0174931 A1
(43) Pub. Date: Jun. 9, 2022

(54) Wasp Catcher

(71) Applicant: Rafael Caceres, Brandon, FL (US)

(72) Inventor: Rafael Caceres, Brandon, FL (US)

(21) Appl. No.: 17/457,748

(22) Filed: Dec. 6, 2021

Related U.S. Application Data
(60) Provisional application No. 63/199,084, filed on Dec. 6, 2020.

(51) Int. Cl. A01M 3/00

(52) U.S. Cl. CPC A01M 3/00

(57) ABSTRACT

Disclosed is a wasp catcher configured to aid a user in removing wasps and their nests from a given area. The wasp catcher has three main components, a telescoping handle, a trigger-activated insecticide, and a flexible containment chamber. The wasp catcher's design allows the user to contain the nest, including the associated wasps, and then release a concentrated dose of insecticide from a disposable capsule directly onto the nest from a safe distance. A trigger located on the handle allows the insecticide capsule to be activated. A pressurized canister, similar to a CO2 canister, can be utilized in which the pressurized contents are released when the canister is punctured. The containment chamber would be made of a flexible material, like silicone or rubber, which will have some transparency to allow the user to sight the nest through the containment chamber.

### CROSS-REFERENCES TO RELATED APPLICATIONS

This Non-Provisional Utility Application claims the benefit of and priority to Provisional Patent Application Ser. No. 63/199,084, filed Dec. 6, 2020, entitled “Wasp Catcher,” the entire contents of which is hereby incorporated herein by reference.

### BACKGROUND

Wasps often nest in hard-to-reach areas, such as underneath roof overhangs or beams, among other obscure areas. If a person knocks the nest down, they risk getting attacked by the wasps. For example, some people get on ladders to knock nests down and then risk being attacked by the stinging insects. In other scenarios, a person may use a long stick, such as a broomstick, to knock the nest down. In any of these situations, the person risks serious injury by getting stung by the wasps.

### SUMMARY

Disclosed is a wasp catcher configured to remove wasps from given areas, namely when nests are present. The wasp catcher has three main components, a telescoping handle, a trigger-activated insecticide, and a flexible containment chamber. The wasp catcher's design allows the user to contain the nest, including the associated wasps, and then release a concentrated dose of insecticide from a disposable capsule directly onto the nest from a safe distance. A trigger located on the handle allows the insecticide capsule to be activated. A pressurized canister, similar to a CO2 canister, can be utilized in which the pressurized contents are released when the canister is punctured.

The containment chamber would be made of a flexible material, like silicone or rubber, which will have some transparency to allow the user to sight the nest through the containment chamber. The wings on the containment chamber's end allow for various surfaces to be covered by the containment chamber by simply pushing the containment chamber against the surface, sealing around the edge to contain the wasps and the insecticide. After activation, the user can wait approximately 30 seconds for the poison to affect the insects before he can knock the nest down in a safer environment.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

### DESCRIPTION OF THE DRAWINGS

FIG. 1 shows an illustrative representation of an exploded view of a wasp catcher;

FIGS. 2 and 3 show illustrative representations of the containment chamber at the top end of the wasp catcher;

FIG. 4 shows an illustrative representation of the wasp catcher's telescoping extensions;

FIG. 5 shows an illustrative representation of the contracted telescoping rods;

FIG. 6 shows an illustrative representation of the extended telescoping rods;

FIG. 7 shows an illustrative representation of the insecticide canister positioned at the top end of the handle;

FIG. 8A shows an illustrative representation of the internal operational features of the trigger and canister;

FIG. 8B show an illustrative representation of the trigger, which utilizes a spring-loaded pressure mechanism;

FIG. 9 shows an illustrative representation of the canister releasing insecticide responsive to the trigger being compressed; and

FIGS. 10-12 show illustrative representations of the was catcher being used against an out-of-reach wasp nest.

Like reference numerals indicate like elements in the drawings. Elements are not drawn to scale unless otherwise indicated.

### DETAILED DESCRIPTION

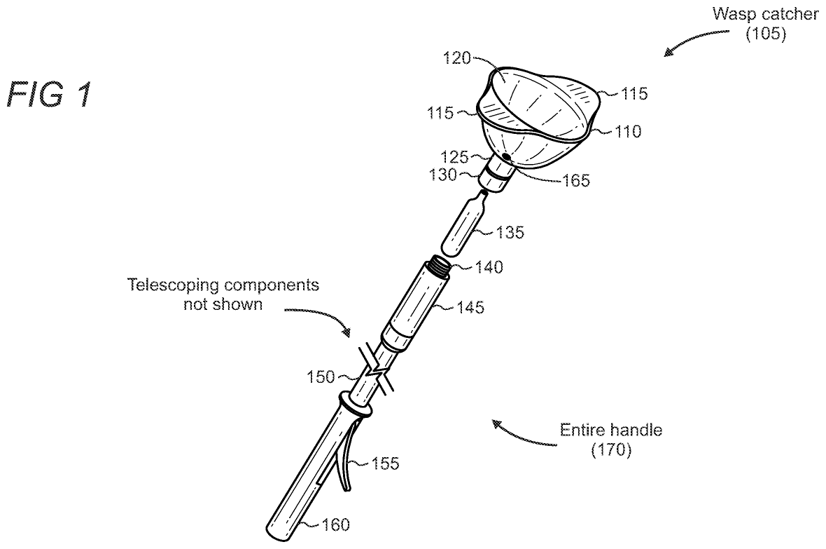

FIG. 1 shows an illustrative representation in which a wasp catcher 105 is adapted with components and features to make knocking down wasp nests easier. More information about the specific details of the wasp catcher is provided in subsequent drawings and discussions herein. The wasp catcher includes a handle 170, representing the entire elongated handle, and a containment chamber 110. The handle 170 has a base handle 160 that includes the trigger 155, which is compressible by a user. The base handle is connected to a rod portion 150, which does not show the telescoping components for ease in illustration. Above the rod portion is a chamber 145 that has a reservoir for receiving at least a portion of the canister 135. The chamber 145 has a threaded portion 140, which connects to corresponding threads on a neck 130. The neck is attached to the receptacle portion 125, which functions as a barrier around the receptacle to which the canister is connected. In typical implementations, the handle 170 components may be comprised of a metal or plastic material. In addition, gripping (e.g., rubber material or ridges) may be placed on the base handle and/or the outside of the chamber 145 to enhance a user's grip.

Above the receptacle is containment chamber 110, which includes an interior 120 and wings 115. The containment chamber may be comprised of silicone material for strength and to provide some malleability during use to accommodate nooks and crannies surrounding the wasp nest. The containment chamber may be partially or fully transparent or at least opaque to enable the user to inspect the actions occurring while using the wasp catcher. Alternatively, the containment chamber may have a window at a portion of the containment chamber to enable the user to have at least some insight underneath the chamber. The window may be comprised of the same or different material as the rest of the containment chamber. For example, the window may be clear plastic that is fastened (e.g., adhesive, bolt and screw, buttons, tab and notch, press-fit, or another fastener) to a corresponding opening in the silicone.

The containment chamber 110 may alternatively be comprised of rubber material, plastic, etc., or a combination thereof. For example, the lower half of the containment chamber may be more rigid, whereas an upper portion may be a malleable material, like silicone or rubber, to accommodate the nest's surrounding structures. A hole 165 is positioned at the bottom of the containment chamber's interior to enable release from the canister. Specifically, the canister's nozzle at least partially extends through the hole to shoot out its contents, such as insecticide or other chemicals against a wasp nest. The structure and function of the canister and containment chamber are discussed in greater detail below.

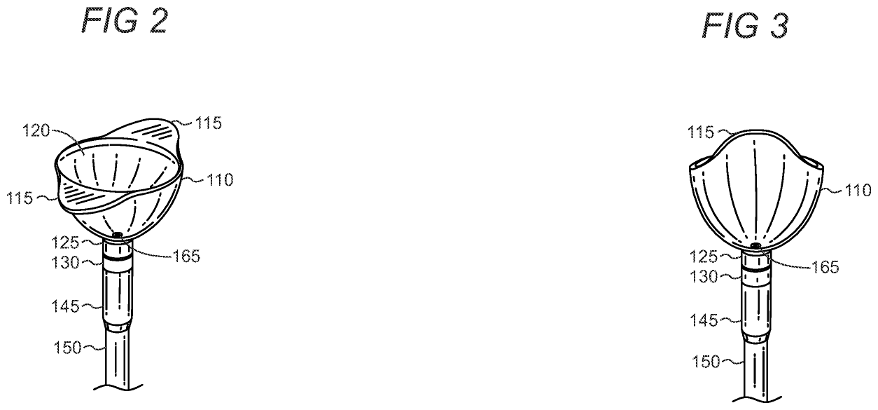

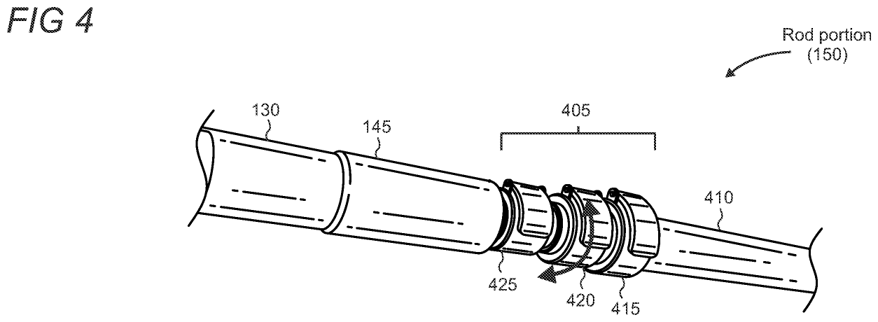

FIGS. 2 and 3 show illustrative representations of the top portion and containment chamber of the wasp catcher 105. The wings are configured to accommodate various wasp nest scenarios and make it easier for the user to contain the wasp nest. Depending on the scenario, one or both of the wings can be in the flattened position or be bent straight up. Alternatively, the containment chamber can be replaceable to accommodate other rim designs. For example, the rim may snugly attach (e.g., a press-fit mechanism) to the receptacle portion 125 to prevent the chamber from detaching during use. However, with sufficient pressure, the user can remove one containment chamber and replace it with another that may have a different rim design (e.g., composition, shape, etc.).

As shown in FIGS. 2 and 3, the chamber 145, when assembled with the corresponding threads on the neck 130, is attached to the neck. The canister (not shown) is inside the chamber's reservoir and has an extended opening that ranges from at least the chamber's reservoir to the hole 165 in the containment chamber. The canister is connected and secured to a receptacle inside the receptacle portion 125 to prevent it from coming loose and enable the canister to shoot out its contents.

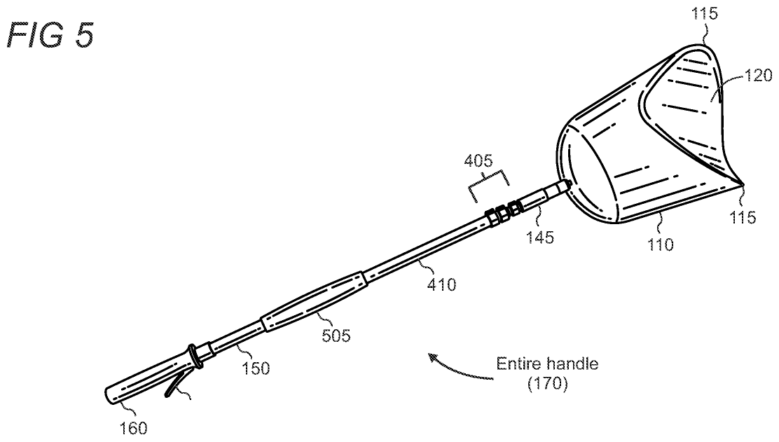

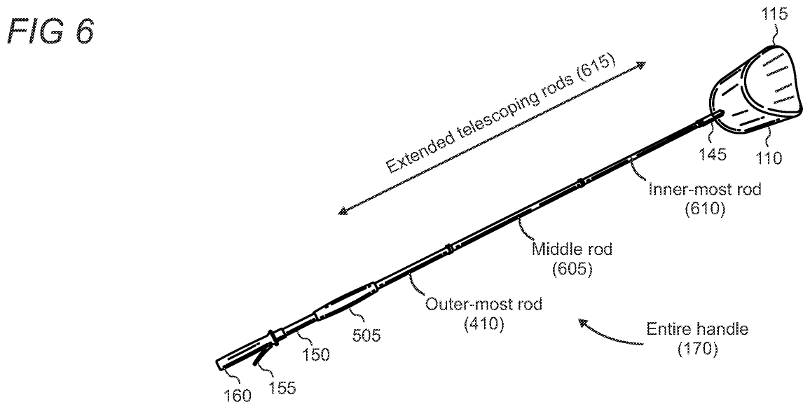

FIGS. 4 and 5 show illustrative representations in which the rod portion 150 is configured with telescoping rods that can be extended or contracted using rotatable knobs 405. The knobs can be rotated clockwise to tighten their grip against the underlying rod or rotated counterclockwise to loosen their grip against the underlying rod. The top knob 425 can be loosened to enable the extension of the inner-most telescoping rod and thereby elongate the entire handle 170. Likewise, the middle knob 420 can be loosened to extend the middle telescoping rod and thereby the handle, and the bottom knob 415 can be loosened to extend the outer-most telescoping rod 410.

These knobs 405 may be tightened again to prevent the extended rods from collapsing. The rods are telescoping in that each rod is hollow to enable the knobs to collapse into each other and extend up to a flange on an end of a lower telescoping rod. Thus, for example, flanges on the middle and bottom telescoping rods prevent the middle rod from being fully released, and a similar configuration is used for the top and middle telescoping rods. The outer-most telescoping rod 410 may collapse into the grip 505.

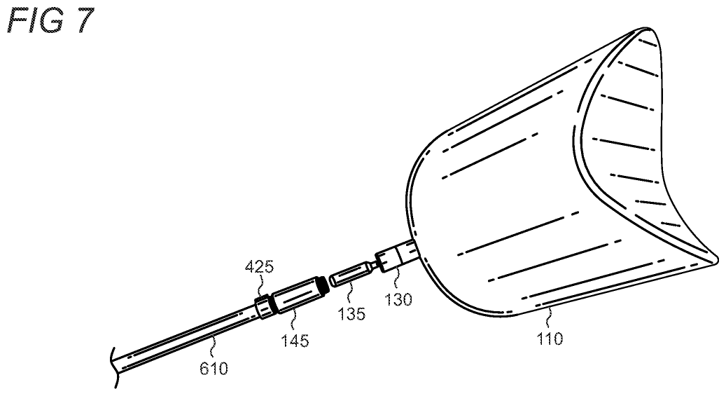

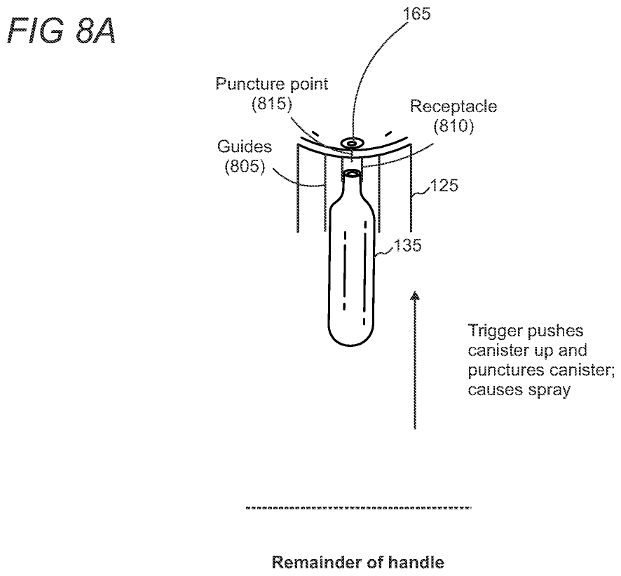

FIG. 6 shows an illustrative representation in which the telescoping rods are fully extended, as representatively shown by numeral 615. The extension of each rod provides greater reach for the wasp catcher 105. The top knob 425 controls the extension or contraction of the inner-most rod 610, the middle knob 420 controls the extension or contraction of the middle rod 605, and the bottom knob 415 controls the extension or contraction of the outer-most rod 410. The chamber 145 is still positioned above the most extended rod (inner-most rod 610) so that the canister 135 can still be controlled and utilized. For example, FIG. 7 shows an illustrative representation in which the canister 135 is positioned inside the chamber 145 and engages with the receptacle portion 125. These components are still positioned above the inner-most rod 610, which may be fully extended.

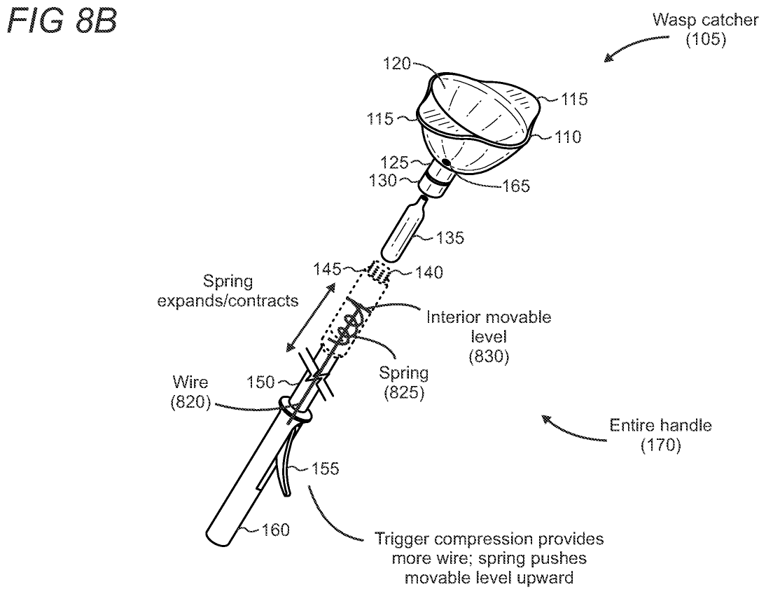

FIG. 8A shows an illustrative representation in which the canister 135 engages with a receptacle 810 within the receptacle portion 125. The receptacle may be configured as a press-fit mechanism or include a tab and notch that the canister latches to. Guides 805 may be positioned adjacent to the receptacle and inside the receptacle portion to make it easier for the user to guide the canister to the receptacle 810. A puncture point 815 may be positioned at or near the center of the hole 165 on the containment chamber 110 so that the top of the canister can be punctured to release its contents. The canister is advanced upward toward and through the puncture point responsive to the user pressing the trigger 155.

The canister's insecticide or other insect poison may be configured with CO2 to enable spraying its contents once it's been punctured by the puncture point 815. Alternatively, a convention spray mechanism may be utilized in which the contents are suctioned up through a tube responsive to a user pulling a nozzle. This may be a different trigger than that shown in the drawings.

FIG. 8B shows an illustrative representation in which the trigger 155 controls the canister's movements inside the chamber's reservoir. The chamber's reservoir includes an interior movable level 830 that at least partially extends across an internal circumference of the chamber 145. Below the movable level 830 is a spring-loaded mechanism that constantly presses upwards against the movable level but is prevented from extending due to the pull of a connected wire 820 at the trigger 155. Thus, when a user pulls the trigger, an additional wire is released so that the spring 825 can continue to push upward against the movable level 810. The wire may be connected to the movable level and a portion of the trigger inside the handle 170. The tensioned wire resists the spring, but the additional give of the wire by the pressed trigger enables the spring to push the movable level further upwards. Moving the level upwards pushes the canister up through the puncture point 815 (FIG. 8A) and advances the canister up through the hole 165 to release its contents.

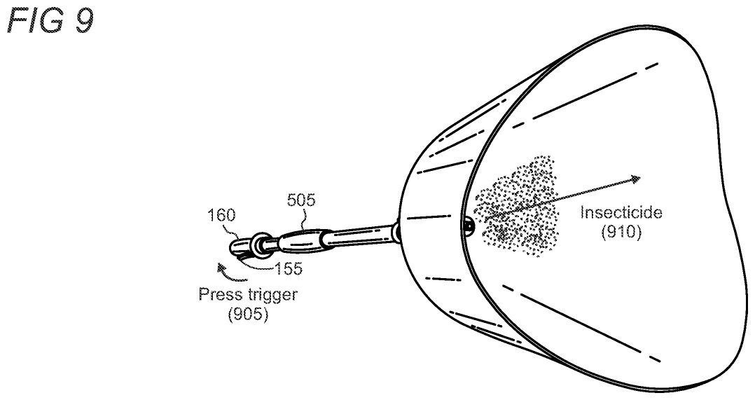

FIG. 9 shows an illustrative representation in which the insecticide 910 is sprayed outward from the hole 165 from the canister 135. This occurs responsive to the user pressing the trigger 155, as representatively shown by numeral 905. The actions that precipitate are shown and described with respect to FIGS. 8A-B, which results in the canister's release. Once the user positions the containment chamber over the wasp nest, the user may press the trigger 155 to release the canister's insecticide. The user may attempt to maintain the position for 30 seconds, or more or less, so the insecticide can at least temporarily run its course before releasing the handle 170 and attempting to knock down the wasp nest completely.

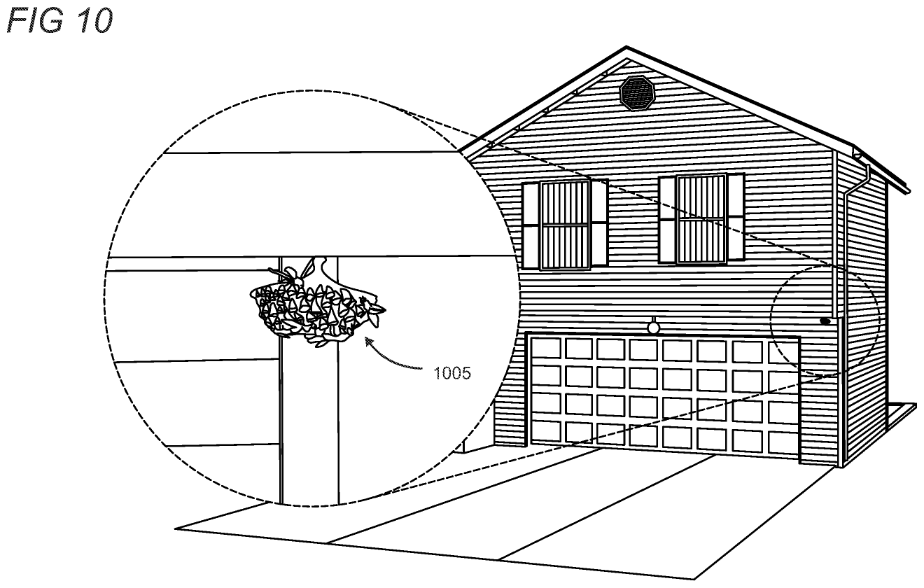

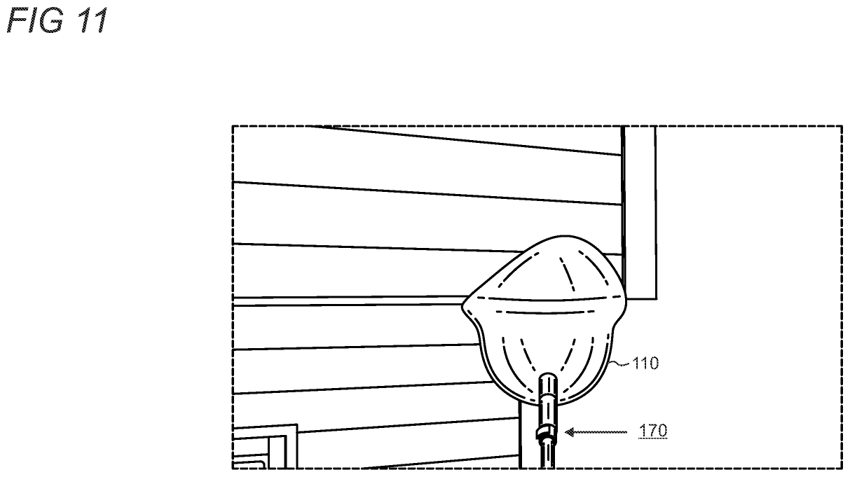

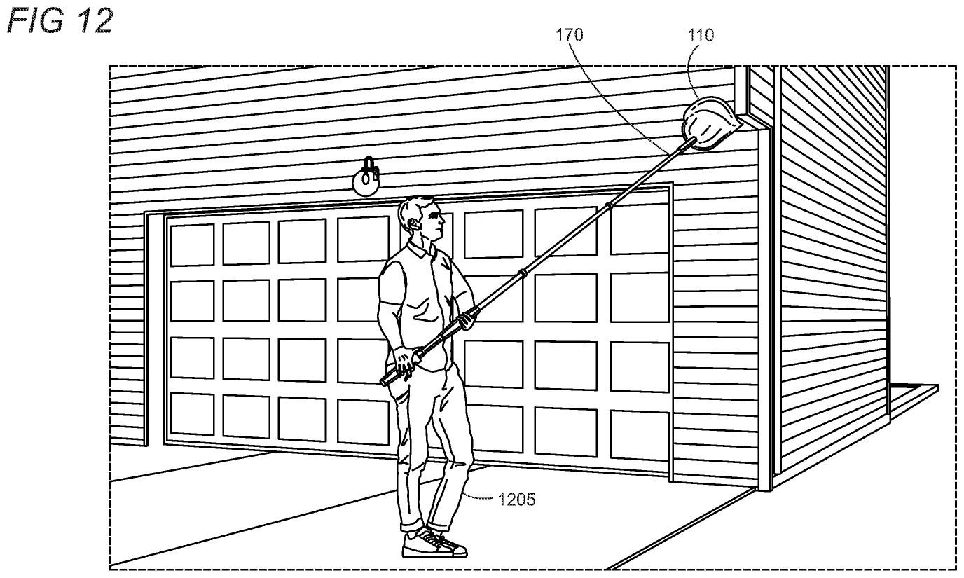

FIGS. 10-12 show illustrative representations of a user 1205 using the wasp catcher 105 in an exemplary scenario. As shown in FIG. 10, the nest 1005 is positioned underneath an overhang of a user's house. FIGS. 11 and 12 show the user positioning and capturing the nest within the containment chamber 110. The wings 115 of the containment chamber's rim is useful due to the configuration of the surrounding structure, which could otherwise enable wasps to escape if not for the rim's unique design features.

Various embodiments of the wasp catcher are discussed and disclosed herein. In one exemplary embodiment, disclosed is a wasp catcher, comprising: a base handle; telescoping rods positioned above the base handle; a chamber positioned above the telescoping rods, the chamber having a reservoir to accommodate a canister; a receptacle that receives the canister, in which a top of the canister is attached to the receptacle, wherein the receptacle includes a barrier that extends around the canister's and receptacle's circumference; and a containment chamber positioned above the receptacle and the barrier, wherein the containment chamber is at least partially bowl-shaped and oriented in a direction opposite the canister.

In another example, further comprising a trigger at the base handle. As another example, wherein the chamber includes threads that rotatably engage with corresponding threads on the barrier surrounding the receptacle, in which attaching the chamber to the barrier causes the canister to be inserted into the chamber. As a further example, the barrier is fastened to a bottom surface of the containment chamber to prevent the containment chamber from detaching from the remainder of the wasp catcher. As another example, further comprising a puncture point that punctures the canister responsive to a user pulling the trigger. In another example, responsive to the trigger being pressed, the canister is pushed upward toward the puncture point. As a further example, the canister extends above a bottom level of the containment chamber and releases its contents. In another example, inside the chamber's reservoir is a movable level that advances upward responsive to the user pressing the trigger. As another example, the trigger is connected to the movable level via a wire that is connected to an assembly which causes the movable level to move upward. As another example, further comprising a loaded spring that exerts pressure against the movable level. In another example, the wire is attached to the movable level and the trigger, in which pressing the trigger gives additional wire which enables the spring to cause the movable level to advance upward.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A wasp catcher, comprising:
a base handle;
telescoping rods positioned above the base handle;
a chamber positioned above the telescoping rods, the chamber having a reservoir to accommodate a canister;
a receptacle that receives the canister, in which a top of the canister is attached to the receptacle, wherein the receptacle includes a barrier that extends around the canister's and receptacle's circumference; and
a containment chamber positioned above the receptacle and the barrier, wherein the containment chamber is at least partially bowl-shaped and oriented in a direction opposite the canister.

2. The wasp catcher of claim 1, further comprising a trigger at the base handle.

3. The wasp catcher of claim 1, wherein the chamber includes threads that rotatably engage with corresponding threads on the barrier surrounding the receptacle, in which attaching the chamber to the barrier causes the canister to be inserted into the chamber.

4. The wasp catcher of claim 3, wherein the barrier is fastened to a bottom surface of the containment chamber to prevent the containment chamber from detaching from the remainder of the wasp catcher.

5. The wasp catcher of claim 4, further comprising a puncture point that punctures the canister responsive to a user pulling the trigger.

6. The wasp catcher of claim 5, wherein, responsive to the trigger being pressed, the canister is pushed upward toward the puncture point.

7. The wasp catcher of claim 6, wherein the canister extends above a bottom level of the containment chamber and releases its contents.

8. The wasp catcher of claim 7, wherein inside the chamber's reservoir is a movable level that advances upward responsive to the user pressing the trigger.

9. The wasp catcher of claim 8, wherein the trigger is connected to the movable level via a wire that is connected to an assembly which causes the movable level to move upward.

10. The wasp catcher of claim 8, further comprising a loaded spring that exerts pressure against the movable level.

11. The wasp catcher of claim 10, wherein the wire is attached to the movable level and the trigger, in which pressing the trigger gives additional wire which enables the spring to cause the movable level to advance upward.
